(19) United States
(12) Patent Application Publication
(10) Pub. No.: US 2012/0163392 A1
(43) Pub. Date: Jun. 28, 2012

(54) PACKET PROCESSING APPARATUS AND METHOD

(75) Inventors: Sang-Kil PARK, Daejeon-si (KR); Sang-Wan KIM, Daejeon-si (KR); Wang-Bong LEE, Daejeon-si (KR); Sang-Sik YOON, Daejeon-si (KR)

(73) Assignee: Electronics and Telecommunications Research Institute, Daejeon-si (KR)

(21) Appl. No.: 13/334,764

(22) Filed: Dec. 22, 2011

(30) Foreign Application Priority Data
Dec. 23, 2010 (KR) 10-2010-0133802

(51) Int. Cl. H04L 12/56

(52) U.S. Cl. 370/401; 370/400

(57) ABSTRACT

A packet processing apparatus and method are provided. According to the packet processing apparatus and method, it is possible to manufacture a product within a short period of time in a case in which there are signals that are not provided by an existing network processing unit (NPU) through a bridging algorithm that is realized in a field programmable gate array (FPGA).

### CROSS-REFERENCE TO RELATED APPLICATION(S)

This application claims the benefit under 35 U.S.C. §119(a) of Korean Patent Application No. 10-2010-0133802, filed on Dec. 23, 2010, in the Korean Intellectual Property Office, the entire disclosure of which is incorporated herein by reference for all purposes.

### BACKGROUND

1. Field

The following description relates to a hardware device that provides a network function, and more particularly, a packet processing apparatus and method that are capable of bridging a ternary content addressable memory (TCAM) via a reduced latency dynamic random access memory (RLDRAM) interface provided by a network processor unit.

2. Description of the Related Art

Due to a rapid increase in the number of handheld devices equipped with a Wireless Fidelity (Wi-Fi) function such as, for example, smart phones, the amount of network traffic has exponentially increased.

In such a network environment, network providers are required to provide multiple traffic streams with high Quality of Service (QoS) via limited network pipes (i.e., bandwidth), and to continue to increase network infrastructure even when no substantial financial benefits are expected.

In the meantime, the demand for network equipment or techniques capable of effectively providing services over a network at high speed using a 10 Gigabit Ethernet (GbE) has steadily grown.

Examples of typical network equipment include switches, routers, in-line equipment with specialized functions, security equipment, and the like, and may perform the functions of application specific integrated chips (ASICs), field programmable gate arrays (FPGAs), network processor units (NPUs), multi-core processors, or many-core processors.

FPGAs may realize and provide a new interface, if necessary, to external chips through FPGA programming.

However, ASICs, NPUs, and core processors may need to be equipped with a bridge function that bridge their interfaces and other interfaces using FPGAs.

### SUMMARY

The following description relates to a field programmable gate array (FPGA) that bridges between two chips that cannot be reprogrammed.

The following description also relates to providing a new signal interface by reprogramming an existing application specific integrated circuit (ASIC) without a requirement of a costly process of manufacturing a new chip.

In one general aspect, there is provided a packet processing apparatus, including: a processor configured to process packets in a network; a memory configured to store a table for performing packet matching in the network; and a gate array configured to bridge between heterogeneous interfaces of the processor and the memory and to provide a communicable interface between the processor and the memory.

The processor may include one of an application specific integrated chip (ASIC), a network processor unit (NPU), a multi-core processor, and a many-core processor and may be further configured to use a predefined interface.

The memory may include a ternary content addressable memory (TCAM) that stores a routing table for search for an IP address in a router or a layer-3 switch.

The gate array may comprise a field programmable gate array (FPGA) that provides an interface between the processor and the memory through programming.

The gate array may be further configured to transmit, receive, and process signals via the interfaces of the processor and the memory and to control the memory in response to a command being issued by the processor.

The packet processing apparatus may further include a traffic interface configured to be connected to the processor, and to receive packets from the outside of the packet processing apparatus or transmit packets that are processed by the processor to the outside of the packet processing apparatus.

The packet processing apparatus may include more than one traffic interface, depending on properties of a network including an amount of traffic.

In another general aspect, there is provided a packet processing method in which a communicable interface is provided between of a processor and a memory in a network device by bridging heterogeneous interfaces of the processor and the memory, including: receiving a packet from an external source; performing a media access control (MAC) address matching operation on the received packet; in response to results of the MAC address matching operation indicating that there is no matching MAC address for the received packet, parsing the received packet; generating a search key using a header field of the received packet and searching the memory using the search key; looking up a table in the memory using a rule index that is returned from the memory; and processing the received packet using a memory value that is looked up from the table.

The packet processing method may further include, in response to the results of the MAC address matching operation indicating that there is a matching MAC address for the received packet, processing the packet in a predefined manner that corresponds to the matching MAC address.

The packet processing method may further include, in response to no rule index being returned from the memory, performing an egress packet control operation on the received packet.

The processing the received packet may include discarding or redirecting the received packet, storing the received packet in the memory, or performing an egress packet control operation according to the memory value.

In another general aspect, there is provided a packet processing method using an FPGA that provides a communicable interface between of an NPU processor and a TCAM in a network device by bridging heterogeneous interfaces of the NPU and the TCAM, including: interpreting a is command relating to a MAC address and an instruction that are received from the NPU based on a predetermined format, and storing the instruction in an instruction queue of the FPGA; transmitting the instruction to a signal bridging block of the FPGA or a TCAM interface according to a purpose of the instruction; in response to the instruction being transmitted to the signal bridging block, storing a predetermined registry value that is returned from the signal bridging block in a result queue of the FPGA; in response to the instruction being transmitted to the TCAM interface, converting the instruction into a TCAM instruction, accessing the TCAM, and storing a predetermined registry value, a data value, or a ‘compare’ research value that is returned from the TCAM, and storing the returned value in the result queue; and transmitting the value stored in the result queue to the NPU.

The packet processing method may further include, in a case in which there is a packet received from the NPU or the value stored in the result queue is to be transmitted to the NPU, converting the received packet or the value stored in the result queue to a predefined format using an interface of the FPGA.

Other features and aspects may be apparent from the following detailed description, the drawings, and the claims.

### BRIEF DESCRIPTION OF THE DRAWINGS

FIG. 1 is a diagram illustrating an example of a packet processing apparatus.

FIG. 2 is a flowchart illustrating an example of a packet processing method.

FIG. 3 is a diagram illustrating an example of processing packets.

FIG. 4 is a table showing examples of read and write signals for use in a field programmable gate array (FPGA) of a packet processing apparatus.

FIG. 5 is a table showing examples of address-based instructions for use in an FPGA of a is packet processing apparatus.

FIG. 6 is a diagram illustrating an example of read and write operations that are performed between heterogeneous interfaces by an FPGA of a packet processing apparatus.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

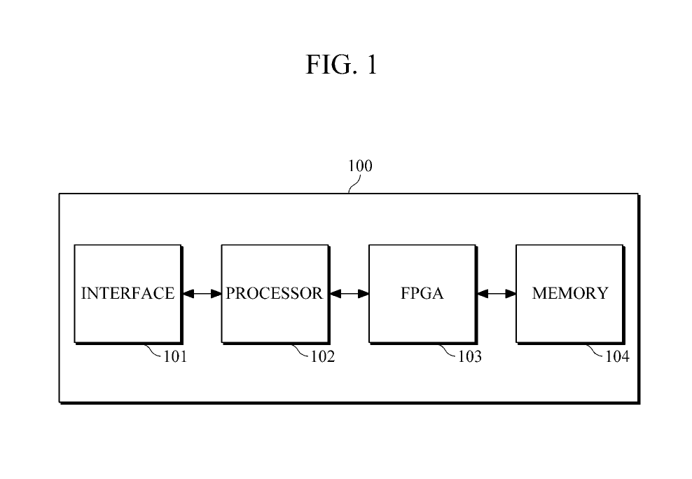

FIG. 1 illustrates an example of a packet processing apparatus. Referring to FIG. 1, packet processing apparatus 100 includes an interface 101, a processor 102, a field programmable gate array (FPGA) 103, and a memory 104.

The processor 102 may process packets in a network. The memory 104 may include a lookup table for performing packet matching in a network.

The FPGA 103 may bridge between heterogeneous interfaces, i.e., the interfaces of the processor 102 and the memory 104, and may provide an interface via which the processor 102 and the memory 104 may communicate with each other.

In response to there being no interface between two hardware chips, i.e., the processor 102 and the memory 104, the packet processing apparatus 100 may receive data from and transmit data to both the interfaces of the processor 102 and the memory 104.

The FPGA 103 may recognize both the interfaces of the processor 102 and the memory 104, and may convert, manage, and apply signals for controlling the memory 104 under the control of the processor 102.

In a case in which the packet processing apparatus 100 is a type of peripheral component interconnect (PCI) or a card installed in an appliance or an Advanced Telecom Computing Architecture (AdvancedTCA) blade, the packet processing apparatus 100 may be equipped with the interface 101, and may transmit or receive packets via the interface 101.

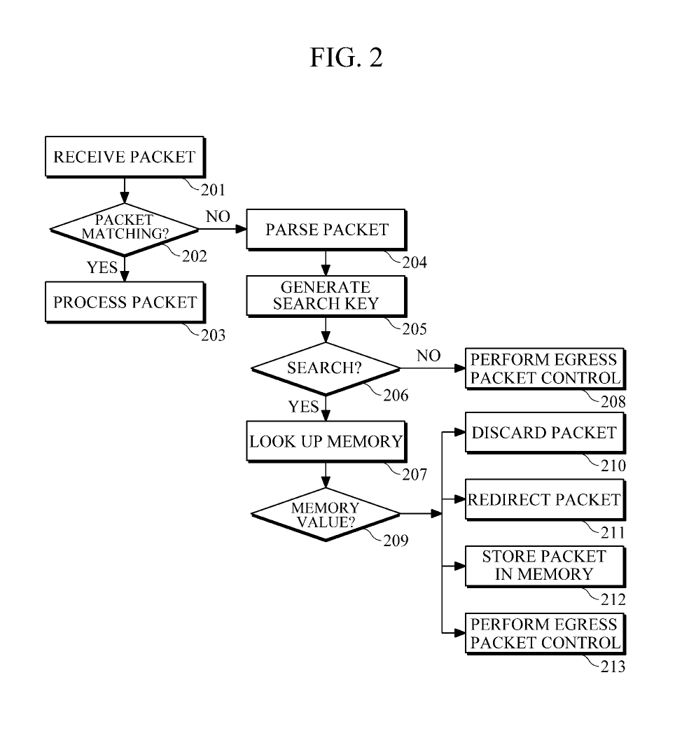

FIG. 2 illustrates an example of a packet processing method, and more particularly, an example of the processing of a packet by the packet processing apparatus 100. Referring to FIG. 2, in 201, the packet processing apparatus 100 may receive an input packet via the interface 101.

In 202, the packet processing apparatus 100 may perform a media access control (MAC) address matching operation to process a MAC address-based packet.

In 203, in response to a desired MAC address being returned as the result of the MAC address matching operation, the packet processing apparatus 100 may process the input packet by performing a predefined response method on the input packet. In 204, in response to no desired MAC address being returned as the result of the MAC address matching operation, the packet processing apparatus 100 may parse the input packet.

The packet processing apparatus 100 may search the memory 104 such as, for example, a ternary content addressable memory (TCAM), using the values of one or more header fields of the input packet such as, for example, a source address, a destination address, protocol information, source port information and destination port information of the input packet.

In 205, the packet processing apparatus 100 may generate a search key based on a header field of the input packet that has the same value as a predefined field value.

In 206, the packet processing apparatus 100 may search the memory 104 using the search key. In 207, in response to a rule index being returned as the result of the search of the memory 104, the packet processing apparatus 100 may look up the memory 104 using the returned rule index.

Various methods to process the input packet may be defined in advance in the memory 104. In 209, a memory value corresponding to the returned index rule may be obtained. In 210 to 213, the packet processing apparatus 100 may process the input packet using a method that is defined in the memory 104 in connection with the memory value.

In response to no rule index being returned from the memory 104, the packet processing apparatus 100 may transmit or copy the input packet to, for example, an asynchronous first-input-first-out (FIFO) memory, to perform egress packet control.

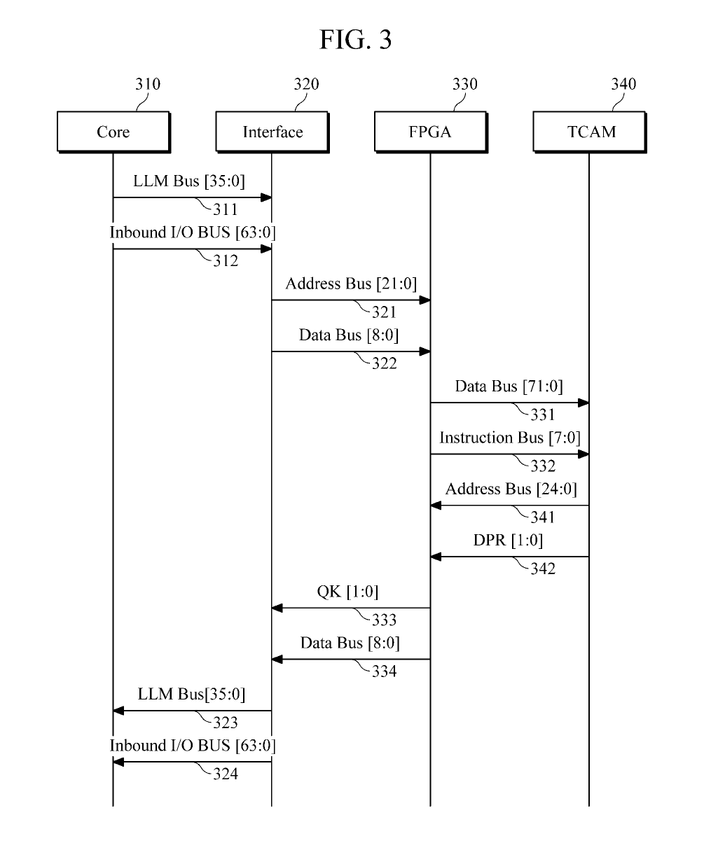

FIG. 3 illustrates an example of the processing of a packet by the packet processing apparatus 100. Referring to FIGS. 1 and 3, the processor 102 may correspond to a core 310, the memory 104 may correspond to a TCAM 340, and the FPGA 103 may correspond to an FPGA 330.

A process for interfacing the core 310 with the TCAM 340 that uses a different interface from the packet processing core 310 is described with reference to FIG. 3.

In a case in which the core 310 is an Octeon core, a packet processing apparatus may apply the FPGA 330 to use the TCAM 340 via the interface 320 such as, for example, a reduced latency dynamic random access memory (RLDRAM) that is provided by a software development kit (SDK), and may interface heterogeneous signals.

Referring to FIG. 3, the core 310, which is a network processor unit (NPU), may access a register in the FPGA 330 or execute a command to use the TCAM 340 by using the interface 320.

In response to a packet being input to the core 310 via a network interface (not shown), the packet may be parsed, and a search key for searching through the TCAM 340 may be generated based on the values of the header fields of the parsed packet, a predetermined value may be generated based on the search key, and the predetermined value may be transmitted to LLM Bus [35:0] (311) and Inbound I/O Bus [63:0] (312) using the interface 320.

An address-based instruction of Address Bus [21:0] (321) that is provided by the interface 320 may be applied as an instruction for use in the FPGA 330 and the TCAM 340 by using the value of a predetermined part of Address Bus [21:0] (321), the address-based instruction may be transmitted to the FPGA 330 using Instruction Bus [7:0] (332), and the parsed packet may be transmitted to the TCAM 340 using Data Bus [8:0] (322) and Data Bus [71:0] (331).

Referring to FIG. 3, Address Bus [24:0] (341) may indicate pattern matching results that are output from the TCAM 340, DPR [1:0] (342) may be a data parity error (DPR) signal that is output from the TCAM 340, QK [1:0] (333) may be a clock signal that is output by the FPGA 330 to the core 310, and that is synchronized when the FPGA 330 outputs data in response to a read command being issued by the core 310, and Data Bus [8:0] (334) may be a data signal that is output by the FPGA 330 to the core 310.

In the above-mentioned manner, the core 310 may access the FPGA 330 or may then access (for example, read data from, write data to, or search through) the TCAM 340 via the FPGA 330.

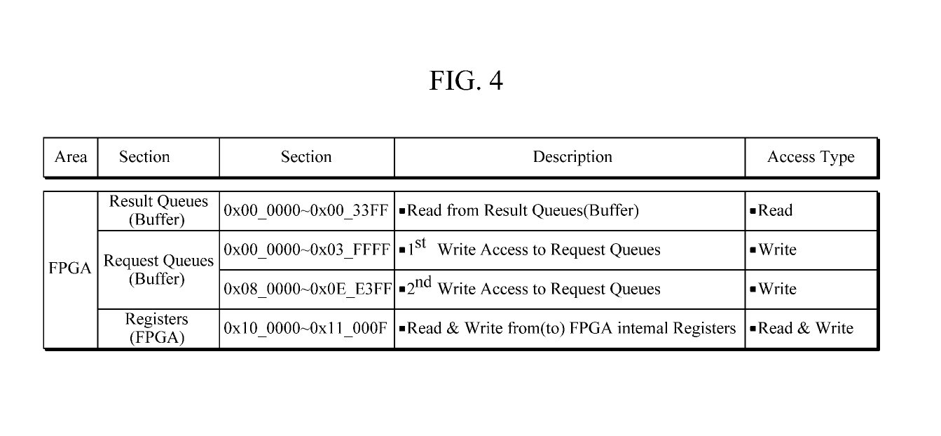

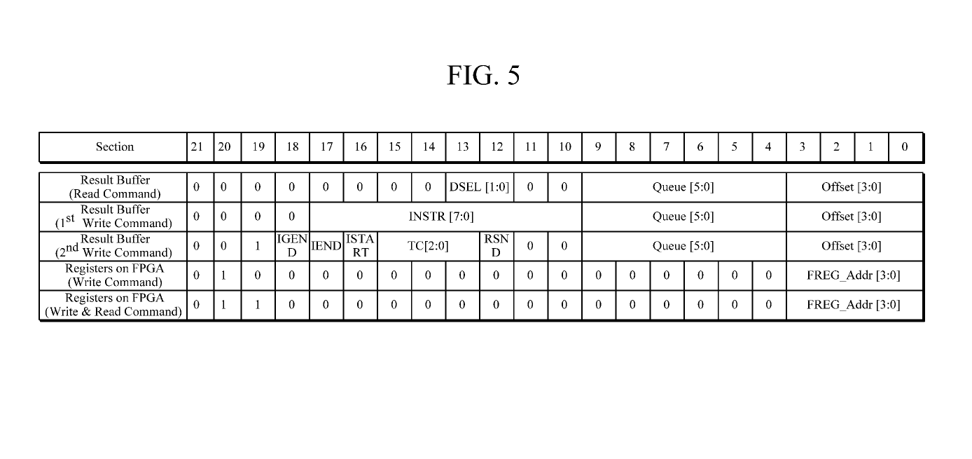

FIG. 4 illustrates examples of read and write signals that may be used in an FPGA of a is packet processing apparatus, and FIG. 5 illustrates examples of address-based instructions that may be used in an FPGA of a packet processing apparatus.

An address-based instruction that may be transmitted to an FPGA may be generated using the tables illustrated in FIGS. 4 and 5.

Referring to FIG. 4, various instructions for the FPGA 330 such as read, 1^{st} write, 2^{nd} write, and read & write may be generated based on the value of Address Bus [21:0] (321).

Referring to FIG. 5, an instruction may be split up based on the value of RLDRAM Address [20:19].

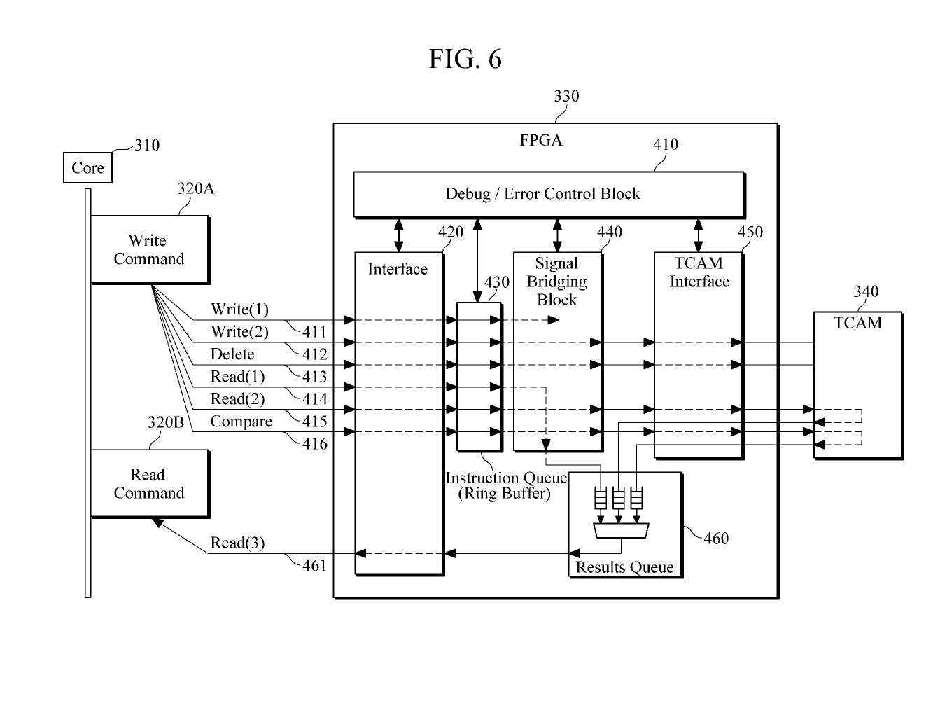

FIG. 6 illustrates an example of performing read and write operations between heterogeneous interfaces by using an FPGA of a packet processing apparatus. Referring to FIG. 6, FPGA 330 includes a debug/error control block 410, an interface 420, an instruction queue 430, a signal bridging block 440, a TCAM interface 450, and a result queue 460.

It is further described with reference to FIG. 6 how the core 310 illustrated in FIG. 3 controls the FPGA 330 and the TCAM 340 based on addresses that are based on the mapping relationship between buses.

Referring to FIGS. 3 and 6, the core 310 may use a predetermined instruction format to control the TCAM 340 via the FPGA 330. Referring to FIG. 6, Write(1) (411), Write(2) (412), Delete (413), Read(1) (414), Read(2) (415), and Compare (416), which are all connected to a write command 320A, may all be associated with a write operation, and Read(3) (461), which is connected to a read command 320B, may be associated with a read operation.

The instruction queue 430 may interpret and store the write command 320A from the core 310 using a predetermined format that is specified in an address and data received along with the write command 320A, and may transmit the address and data to the signal bridging block 440.

The signal bridging block 440 may include a total of 64 request queues (not shown). The 64 request queues may convert data that is provided by the instruction queue 430 to a predetermined format, and may store the results of the conversion therein. The signal bridging block 440 may transmit data to the TCAM interface 450 or the result queue 460 in a predefined order.

The TCAM interface 450 may convert data that is provided by the signal bridging block 440 by using the TCAM interface 450, and may thus transmit an instruction to the TCAM 340.

The result queue 460 may store data that is provided by the signal bridging block 440 or the TCAM interface 450 in buffer A, B, or C (not shown) therein, and may transmit the stored data to the core 310 in response to Read(1) (414) and Read(2) (415) of the core 310.

For example, the core 310 may be an Octeon RLDRAM-II interface port.

For example, the FPGA 330 may be an Altera Stratix-II EP2S30 FPGA.

For example, the write command 320A may be a write command block of the core 310 for the FPGA 330.

For example, Write(1) (411) may be a command to write data to a predetermined register in the FPGA 330. In response to Write(1) (411) being received, the FPGA 330 may interpret Write(1) (411), and may write data to the predetermined register of the FPGA 330.

For example, Write(2) (412) may be a command to write data to the TCAM 340 via the FPGA 330. In response to Write(2) (412) being received, the FPGA 330 may interpret Write(2) (412), and may issue a command for TCAM 340 to write data to a predetermined register in the TCAM 340 or Data/Mask.

For example, Delete (413) may be a command for the core 310 to delete data from the TCAM 340 via the FPGA 330. In response to Delete (413) being received, the FPGA 330 may interpret Delete (413), and may issue a command to delete data from the predetermined register is of the TCAM 340 or to delete a predetermined data/mask value from the TCAM 340.

For example, Read(1) (414) may be a command to read data from a predetermined register in the FPGA 330. In response to Read(1) (414), data may be read out from the predetermined register in the FPGA 330, and the read-out data may be stored in buffer A of the result queue 460. The core 310 may read the read-out data from buffer A using Read(3) (461).

For example, Read(2) (415) may be a command for the core 310 to read data from a predetermined register in the TCAM 340 via the FPGA 330 or to read a predetermined data/mask value from the TCAM 340. In response to Read(2) (415) being received, the FPGA 330 may interpret Read(2) (415), and may issue a command to read data from the predetermined register in the TCAM 340 or to read the predetermined data/mask value from the TCAM 340. The FPGA 330 may store data that is returned from the TCAM 340 in buffer B of the result queue 460. The core 310 may read the returned data from buffer B using Read(3) (461).

For example, Compare (416) may be a command for the core 310 to obtain predetermined result data from the TCAM 340 by applying a desired pattern to the TCAM 340. In response to Compare (416) being received, the FPGA 330 may interpret Compare (416), and may issue a compare command to the TCAM 340. The TCAM 340 may output comparison results, and the FPGA 330 may store the comparison results in buffer C of the result queue 460. The core 310 may read the comparison results from buffer C by using Read(3) (461).

The interface 420 may interface the core 310 with the instruction queue 430 of the FPGA 330. The FPGA 330 may convert an address and data that are provided by the core 310 to a format appropriate for use in the FPGA 330, and may transmit the results of the conversion to the instruction queue 430.

The instruction queue 430 may receive an address and data from the interface 420, may interpret the received address and the received data, and may perform a predetermined operation is based on the results of the interpretation. For example, in response to the results of the interpretation indicating that a command to read the value of a predetermined register from the FPGA 330 has been issued, the instruction queue 430 may store the value of the predetermined register in buffer A of the result queue 460. For example, in response to the results of the interpretation indicating that there is a command that needs to be transmitted to the TCAM 340, the instruction queue 430 may transmit the command to the TCAM interface 450.

The signal bridging block 440 may control the interactions between all interface blocks in the FPGA 330, may transmit commands, and may detect any error in the transmission of data through command sequence numbering.

The FPGA 330 may include a plurality of request queues. A command to access (for example, read data from or write data to) a register in the FPGA 330 may be converted to a predetermined format, and the converted command may be stored in the request queues. The converted command may be transmitted to the TCAM interface 450 or the result queue 460.

The TCAM interface 450 may receive a command from the signal bridging block 440 into a TCAM interface command, and may access (for example, read data from or write data to) the TCAM 340 in response to the TCAM interface command. The TCAM interface 450 may receive a register value, a data value or a ‘compare’ search value from the TCAM 340, and may transmit the received value to the result queue 460.

The result queue 460 may store data that is provided by the FPGA 330 or the TCAM interface 450 in buffers A, B, and C.

For example, the value of a predetermined register in the FPGA 330 may be stored in buffer A.

For example, the value of a predetermined register in the TCAM 340 and a data/mask is value read out from the TCAM 340 may be stored in buffer B.

For example, a predetermined index value (or a TCAM address) read out from the TCAM 340 may be stored in buffer C.

In response to a read command being received from the core 310, the result queue 460 may read data out from a buffer that is associated with the read command, and may transmit the read-out data to the core 310.

By using Read(3) (461), which is a read command issued by the core 310, the core 310 may read the value of a predetermined register in the FPGA 330, the value of a predetermined register in the FPGA 330 or a data/mask value.

For example, the read command 320B may be a read command issued by the core 310.

The debug/error control block 410 may determine, handle, and manage any error that may occur in each of the blocks of the FPGA 330, and may mediate between the blocks of the FPGA 330.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

As described above, it is possible to manufacture a product within a short period of time in a case in which there are signals that are not provided by an existing NPU through a bridging algorithm that is realized in an FPGA.

In addition, it is possible for a card that processes packet information using an NPU to classify packets at high speed through TCAM packet matching.

Moreover, it is possible to provide an NPU capable of automating additional packet payload searching and protocol analysis.

Furthermore, it is possible to classify packets at high speed by using an FPGA in a case in which an interface for a predetermined TCAM is not provided.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other is implementations are within the scope of the following claims.

What is claimed is:

1. A packet processing apparatus, comprising:
a processor configured to process packets in a network;
a memory configured to store a table for performing packet matching in the network; and
a gate array configured to bridge between heterogeneous interfaces of the processor and the memory and to provide a communicable interface between the processor and the memory.

2. The packet processing apparatus of claim 1, wherein the processor comprises one of an application specific integrated chip (ASIC), a network processor unit (NPU), a multi-core processor, and a many-core processor and is further configured to use a predefined interface.

3. The packet processing apparatus of claim 1, wherein the memory comprises a ternary is content addressable memory (TCAM) that stores a routing table for search for an IP address in a router or a layer-3 switch.

4. The packet processing apparatus of claim 1, wherein the gate array comprises a field programmable gate array (FPGA) that provides an interface between the processor and the memory through programming.

5. The packet processing apparatus of claim 1, wherein the gate array is further configured to transmit, receive, and process signals via the interfaces of the processor and the memory and to control the memory in response to a command being issued by the processor.

6. The packet processing apparatus of claim 1, further comprising:
a traffic interface configured to be connected to the processor, and to receive packets from the outside of the packet processing apparatus or transmit packets that are processed by the processor to the outside of the packet processing apparatus.

7. The packet processing apparatus of claim 6, wherein the packet processing apparatus includes more than one traffic interface, depending on properties of a network including an amount of traffic.

8. A packet processing method in which a communicable interface is provided between of a processor and a memory in a network device by bridging heterogeneous interfaces of the processor and the memory, comprising:
receiving a packet from an external source;
performing a media access control (MAC) address matching operation on the received packet;
in response to results of the MAC address matching operation indicating that there is no matching MAC address for the received packet, parsing the received packet;
generating a search key using a header field of the received packet and searching the memory using the search key;
looking up a table in the memory using a rule index that is returned from the memory; and
processing the received packet using a memory value that is looked up from the table.

9. The packet processing method of claim 8, further comprising:
in response to the results of the MAC address matching operation indicating that there is a matching MAC address for the received packet, processing the packet in a predefined manner that corresponds to the matching MAC address.

10. The packet processing method of claim 8, further comprising:
in response to no rule index being returned from the memory, performing an egress packet control operation on the received packet.

11. The packet processing method of claim 8, wherein the processing the received packet comprises discarding or redirecting the received packet, storing the received packet in the memory, or performing an egress packet control operation according to the memory value.

12. A packet processing method using an FPGA that provides a communicable interface is between of an NPU processor and a TCAM in a network device by bridging heterogeneous interfaces of the NPU and the TCAM, comprising:
interpreting a command relating to a MAC address and an instruction that are received from the NPU based on a predetermined format, and storing the instruction in an instruction queue of the FPGA;
transmitting the instruction to a signal bridging block of the FPGA or a TCAM interface according to a purpose of the instruction;
in response to the instruction being transmitted to the signal bridging block, storing a predetermined registry value that is returned from the signal bridging block in a result queue of the FPGA;
in response to the instruction being transmitted to the TCAM interface, converting the instruction into a TCAM instruction, accessing the TCAM, and storing a predetermined registry value, a data value, or a ‘compare’ research value that is returned from the TCAM, and storing the returned value in the result queue; and
transmitting the value stored in the result queue to the NPU.

13. The packet processing method of claim 12, further comprising:
in a case in which there is a packet received from the NPU or the value stored in the result queue is to be transmitted to the NPU, converting the received packet or the value stored in the result queue to a predefined format using an interface of the FPGA.
